(19) United States
(12) Patent Application Publication
(10) Pub. No.: US 2008/0211612 A1
(43) Pub. Date: Sep. 4, 2008

(54) Hybrid Coils Having an Improved Heat Transfer Capability

(75) Inventor: Johan C. Compter, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,931

(22) PCT Filed: Jul. 21, 2006
(86) PCT No.: PCT/IB06/52511

§ 371 Date: Jan. 17, 2008

Related U.S. Application Data
(60) Provisional application No. 60/702,221, filed on Jul. 25, 2005.

(51) Int. Cl. H01F 27/08

(52) U.S. Cl. 336/61

(57) ABSTRACT

A hybrid coil (11) employs a wire layer (22), a wire layer (23) adjacent the wire layer (22), and a wire layer (24) adjacent the wire layer (23). The hybrid coil (11) further employs a thermal conductive insulator (42) physically disposed within a space between the wire layer (22) and the wire layer (23), and a thermal conductive insulator (43) physically disposed within a space between the wire layer (23) and the wire layer (24). The thermal conductive insulators (42, 43) can be electrically disconnected, and each thermal conductive insulator (42, 43) can consists of an aluminum foil (42a, 43a) having oxide layers (42b, 43b, 42c, 43c) on each side thereof.

The present invention generally relates to hybrid coils based on a thermal relationship between wires and thermal conductive insulators. The present invention specifically relates to improving the heat transfer capability of such hybrid coils.

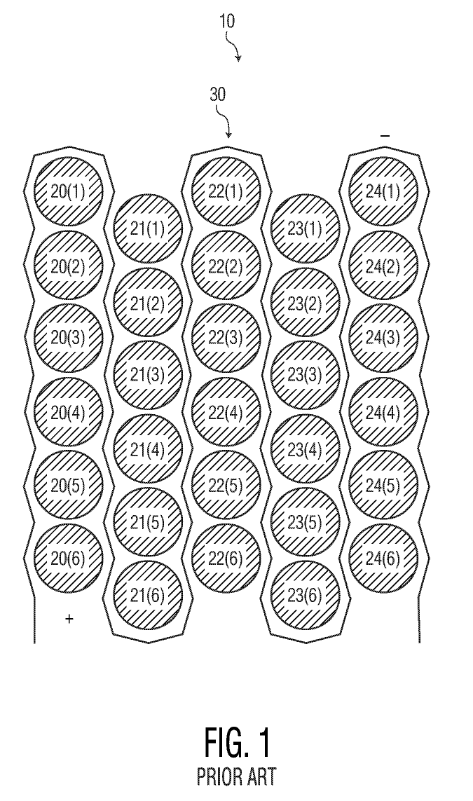

FIG. 1 illustrates one part of a hybrid coil 10 employing a winding of five (5) spaced apart wire layers 20-24. Wire layer 20 consists of wires 20(1)-20(6). Wire layer 21 consists of wires 21(1)-21(6). Wire layer 22 consists of wires 22(1)-22(6). Wire layer 23 consists of wires 23(1)-23(6). Wire layer 24 consists of wires 24(1)-24(6). To direct excess heat away from wire layers 20-24, a thermal conductive insulator 30 is interleaved between wire layers 20-24 as shown.

One drawback to the use of thermal conductive insulator 30 for directing excess heat way from wire layers 20-24 is a harmful potential for insulator 30 to withstand a full voltage differential (+−) applied to hybrid coil 10, such as, for example, in an over-load condition or a high voltage test. Furthermore, it is common practice to employ copper as a primary thermal conductive material for thermal conductive insulator 30 even in operational environments where the electrical resistivity and/or weight of copper are disadvantageous to the overall operation. To overcome this drawbacks, the present invention provides new and improved hybrid coils.

In a first form of the present invention, a hybrid coil comprises a pair of wire layers, and a thermal conductive insulator disposed within a space between the pair of wire layers, wherein the thermal conductive insulator includes an aluminum foil.

In a second form of the present invention, the thermal conductive insulator further includes an oxide layer formed on each side of the aluminum foil.

In a third form of the present invention, a hybrid coil comprises three wire layers, a first thermal conductive insulator disposed within a space between a first adjacent pair of the three wire layers and a second thermal conductive insulator disposed within a space between a second adjacent pair of the three wire layers, wherein the thermal conductive insulators are electrically disconnected.

The foregoing forms and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

FIG. 1 illustrates a cross-sectional view of one embodiment of a hybrid coil as known in the art;

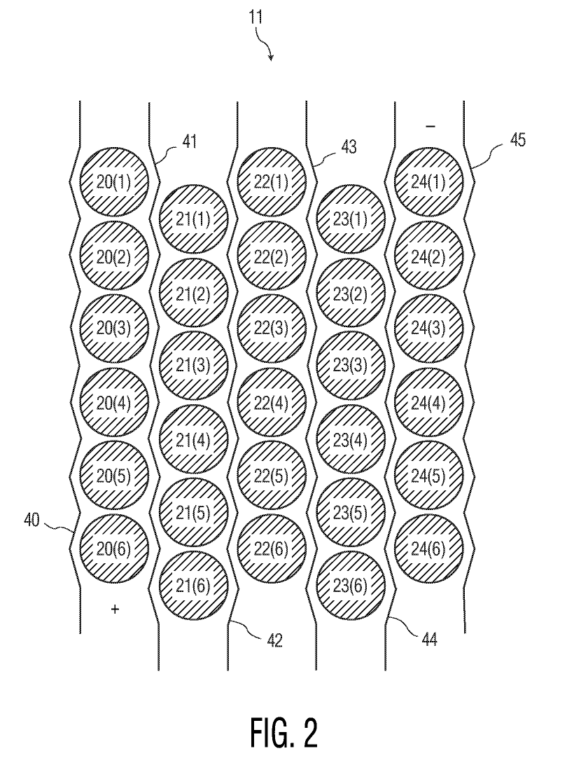

FIG. 2 illustrates a cross-sectional view of one embodiment of a hybrid coil in accordance with the present invention;

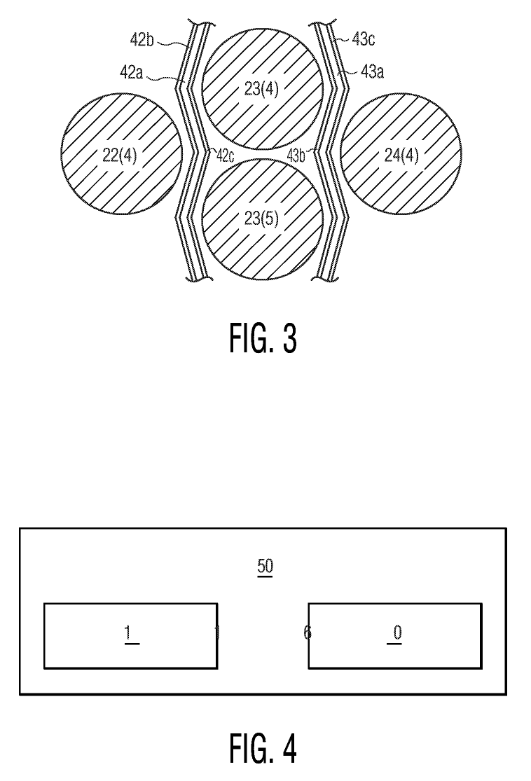

FIG. 3 illustrates a cross-sectional view of one embodiment of a thermal conductive insulator in accordance with the present invention; and

FIG. 4 illustrates a device employing the hybrid coil illustrated in FIG. 2.

Referring to FIG. 2, a part of a hybrid coil 11 employs the winding of wire layers 20-24 and electrically disconnected thermal conductive insulators 40-45. To direct excess heat away from wire layer 20, a pair of thermal conductive insulators 40 and 41 are physically disposed on each side of wire layer 20. To direct excess heat away from wire layer 21, a pair of thermal conductive insulators 41 and 42 are physically disposed on each side of wire layer 21. To direct excess heat away from wire layer 22, a pair of thermal conductive insulators 42 and 43 are physically disposed on each side of wire layer 22. To direct excess heat away from wire layer 23, a pair of thermal conductive insulators 43 and 44 are physically disposed on each side of wire layer 23. To direct excess heat away from wire layer 24, a pair of thermal conductive insulators 44 and 45 are physically disposed on each side of wire layer 24. In particular, each insulator 42-44 is physically disposed within a space between a respective pair of adjacent wire layers 20-24, while insulators 40 and 45 enclose respective wire layers 20 and 24.

In one embodiment, insulators 40-45 are in physical contact, directly or indirectly, with respective wire layers 20-24 as would be appreciated by those having ordinary skill in the art.

In practice, the present invention does not impose any limitations or any restrictions as to the physical dimensioning of insulators 40-45, except to ensure that insulators 40-45 direct excess heat from respective wire layers 20-24 and to facilitate a cooling of insulators 40-45 as would be appreciated by those having ordinary skill in the art.

Also in practice, the present invention does not impose any limitations or any restrictions as to the material composition of insulators 40-45. Thus, the following description of one material composition embodiment of insulators 40-45 as illustrated in FIG. 3 is not a limitation or a restriction as to the scope of material composition of insulators 40-45.

Referring to FIG. 3, one material composition for each insulator 40-45 includes an aluminum foil having an oxide coating. In particular, as shown in FIG. 3, insulator 42 has an aluminum foil 42a with an oxide layer 42b on a side of foil 42a facing wire layer 22 and an oxide layer 42c of an opposing side of foil 42a facing wire layer 23. Similarly, insulator 43 has an aluminum foil 43a with an oxide layer 43b on a side of foil 43a facing wire layer 23 and an oxide layer 43c of an opposing side of foil 43a facing wire layer 24.

Referring again to FIG. 2, in embodiments where an insulators includes an aluminum foil having coating as taught herein, fewer insulators can be used to directed excess away from wire layers 20-25, such as, for example, insulators 41 and 44 may be omitted in such embodiments.

Referring to FIG. 4, hybrid coil 11 can be operated by a device 50 (e.g., an electric beam equipment, a motor, an actuator, a transformer, and a ballast) having a cooling mechanism 60 for cooling the insulators 40-45 of hybrid coil 11. In one embodiment, cooling mechanism 60 forces air over the insulators 40-45 as would be appreciated by those having ordinary skill in the art to thereby cool insulators 40-45. In a second embodiment, cooling mechanism 60 connects insulators 40-45 to one or more heat well conducting strips as would be appreciated by those having ordinary skill in the art to thereby cool insulators 40-45 by air, a gas or a fluid.

Referring to FIGS. 2-4, those having ordinary skills in the art will appreciate numerous advantages of the present invention including, but not limited to, addressing the drawbacks of the background art previously described herein. In particular, electrically disconnected insulators will suffer less structural damage in an over-load condition or a high voltage test of a hybrid coil of the present invention. Furthermore, aluminum is suitable to be fabricated as bendable sheet of thermal conductive material with an oxide coating providing a thinner insulation layer for the aluminum as compared to a polymer typically used to coat copper when copper is used as the primary thermal conductive material. Additionally, aluminum offers a specific weight of 2.7 kg/dm⁴ that is lower than copper's weight of 8.9 kg/dm⁴.

Embodiments of the present invention have been described above by way of example only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. A hybrid coil (11), comprising:
a first wire layer (22);
a second wire layer (23); and
a first thermal conductive insulator (42) disposed within a space between the first wire layer (22) and the second wire layer (23), wherein the first thermal conductive insulator (42) includes a first aluminum foil (42a).

2. The hybrid coil (11) of claim 1, wherein the first thermal conductive insulator (42) further includes an oxide layer (42b) between the first wire layer (22) and the first aluminum foil (42a).

3. The hybrid coil (11) of claim 1, wherein the first thermal conductive insulator (42) further includes an oxide layer (42c) between the second wire layer (23) and the first aluminum foil (42a).

4. The hybrid coil (11) of claim 1, further comprising:
a third wire layer (24); and
a second thermal conductive insulator (43) disposed within a space between the second wire layer (23) and the third wire layer (24), wherein the first thermal conductive insulator (42) and the second thermal conductive insulator (43) are electrically disconnected.

5. The hybrid coil (11) of claim 4, wherein the first thermal conductive insulator (42) further includes an oxide layer (42b) between the first wire layer (22) and the first aluminum foil (42a).

6. The hybrid coil (11) of claim 4, wherein the first thermal conductive insulator (42) further includes an oxide layer (42c) between the second wire layer (23) and the first aluminum foil (42a).

7. The hybrid coil (11) of claim 1, wherein the hybrid coil (11) is operated within a device (50) selected from a group including an electric beam equipment, a motor, an actuator, a transformer, and a ballast.

8. A hybrid coil (11), comprising:
a first wire layer (22);
a second wire layer (23); and
a first thermal conductive insulator (42) disposed within a space between the first wire layer (22) and the second wire layer (23), wherein the first thermal conductive insulator (42) includes:
a first aluminum foil (42a);
a first oxide layer (42b) between the first wire layer (22) and the first aluminum foil (42a); and
a second oxide layer (42c) between the second wire layer (23) and the first aluminum foil (42a).

9. The hybrid coil (11) of claim 8, further comprising:
a third wire layer (24); and
a second thermal conductive insulator (43) disposed within a space between the second wire layer (23) and the third wire layer (24), wherein the second thermal conductive insulator (43) includes:
a second aluminum foil (44a);
a third oxide layer (43b) between the second wire layer (23) and the second aluminum foil (43a); and
a fourth oxide layer (43c) between the third wire layer (24) and the third aluminum foil (43a).

10. The hybrid coil (11) of claim 8, further comprising:
a third wire layer (24); and
a second thermal conductive insulator (43) disposed within a space between the second wire layer (23) and the third wire layer (24), wherein the first thermal conductive insulator (42) and the second thermal conductive insulator (43) are electrically disconnected.

11. The hybrid coil (11) of claim 10, wherein the second thermal conductive insulator (43) includes:
a second aluminum foil (44a);
a third oxide layer (43b) between the second wire layer (23) and the second aluminum foil (43a); and
a fourth oxide layer (43c) between the third wire layer (24) and the third aluminum foil (43a).

12. The hybrid coil (11) of claim 8, wherein the hybrid coil (11) is operated within a device (50) selected from a group including an electric beam equipment, a motor, an actuator, a transformer, and a ballast.

13. A hybrid coil (11), comprising:
a first wire layer (22);
a second wire layer (23) adjacent the first wire layer (22);
a first thermal conductive insulator (42) disposed within a space between the first wire layer (22) and the second wire layer (23);
a third wire layer (24) adjacent the second wire layer (23); and
a second thermal conductive insulator (43) disposed within a space between the second wire layer (23) and the third wire layer (24), wherein the first thermal conductive insulator (42) and the second thermal conductive insulator (43) are electrically disconnected.

14. The hybrid coil (11) of claim 13, wherein the first thermal conductive insulator (42) further includes a first aluminum foil (42a).

15. The hybrid coil (11) of claim 14, wherein the first thermal conductive insulator (42) further includes a first oxide layer (42b) between the first wire layer (22) and the first aluminum foil (42a).

16. The hybrid coil (11) of claim 15, wherein the first thermal conductive insulator (42) further includes a second oxide layer (42c) between the second wire layer (23) and the first aluminum foil (42a).

17. The hybrid coil (11) of claim 16, wherein the second thermal conductive insulator (43) further includes a second aluminum foil (43a).

18. The hybrid coil (11) of claim 17, wherein the second thermal conductive insulator (43) further includes a third oxide layer (43b) between the second wire layer (23) and the second aluminum foil (43a).

19. The hybrid coil (11) of claim 18, wherein the second thermal conductive insulator (43) further includes a fourth oxide layer (43c) between the third wire layer (24) and the second aluminum foil (43a).

20. The hybrid coil (11) of claim 13, wherein the hybrid coil (11) is operated within a device (50) selected from a group including an electric beam equipment, a motor, an actuator, a transformer, and a ballast.
